(19) United States
(12) Patent Application Publication
(10) Pub. No.: US 2024/0042581 A1
(43) Pub. Date: Feb. 8, 2024

(54) SOCKET FOR TIGHTENING AND LOOSENING NORMAL AND WORN BOLTS

(71) Applicants: Yao-Lin Cho, Taichung City (TW); Zi-Yan Huang, Taichung City (TW); Chih-Chao Chang, Taichung City (TW)

(72) Inventors: Yao-Lin Cho, Taichung City (TW); Zi-Yan Huang, Taichung City (TW); Chih-Chao Chang, Taichung City (TW)

(21) Appl. No.: 18/379,177

(22) Filed: Oct. 12, 2023

Related U.S. Application Data
(63) Continuation-in-part of application No. 17/207,724, filed on Mar. 21, 2021.
Application No. 17/207,724 is a continuation-in-part of application No. 16/587,051, filed on Sep. 30, 2019, now abandoned.
Application No. 16/587,051 is a continuation-in-part of application No. 15/638,369, filed on Jun. 30, 2017, now abandoned.

(51) Int. Cl. B25B 13/06; B25B 23/00

(52) U.S. Cl. CPC B25B 13/065; B25B 23/0035

(57) ABSTRACT

A socket is portably and removably attached to a tool and includes a body with a mounting hole which includes multiple faces. Each face includes a first protrusion and two groups of second protrusions located on two sides of the first protrusion. The first protrusion of each face includes a first flat distal surface which has a certain length. Each second protrusion includes a second flat distal surface which is tilt relative to the first flat distal surface. The two respective slopes of the second flat distal surfaces of the two groups of the second protrusions are opposite to each other. A first imaginary plane is co-linear with the first flat distal surface. A second imaginary plane is co-linear with the second flat distal surfaces of each second protrusion. An angle is formed between the first and second imaginary planes. The socket can drive a normal or rounded bolt.

### BACKGROUND OF THE INVENTION

### 1. Fields of the Invention

This application is a Continuation-In-Part application of applicant's formal patent application with application Ser. No. 17/207,724, filed on Mar. 21, 2021.

### 2. Descriptions of Related Art

Sockets are provided with a mounting hole which generally is a polygonal hole, the polygonal hole includes multiple faces which are designed to be in contact with sides of a nut or a bolt head. The sockets can be connected with a tool such as a wrench, and when the wrench is rotated, the socket is rotated to loosen the nut or bolt head. However, if the nut or bolt head is rounded or damaged, the faces of the polygonal hole are not in contact with the sides of the nut or bolt head, then the rotation of the socket cannot drive the nut or bolt head.

U.S. Pat. No. 6,851,336 discloses a socket which has a mounting hole with twelve faces which are grouped into six triangular protrusions. Each triangular protrusion includes two faces intersects at a peak. A normal bolt head with six sides are respectively in contact with six of the twelve faces of the mounting hole. However, when a rounded bolt head is to be rotated, the peaks of the triangular protrusions cannot provide sufficient grabbing force to the rounded bolt head.

Please refer to the U.S. Pat. No. 5,148,726 titled “One-piece, open-end wrenching head with roughened jaws.” As disclosed in FIG. 6 of the patent, a wrench with a driving surface 106 is disclosed, and the driving surface 106 is composed of serrated regions 108 and 110 separated by a first flat surface 112. The serrated region 108 includes multiple grooves 114 alternating with multiple second flat surfaces 116, and the serrated region 110 includes multiple grooves 118 alternating with multiple second flat surfaces 120. The second flat surfaces 116 and the second flat surfaces 120 of the serrated regions 108 and 110 are in contact with the sides of the bolt. Due to the inclined design of the multiple grooves 114 and 118 in serrated regions 108 and 110, meaning that the sides of the grooves 114 and 118 are not symmetrical. The first flat surface 112 and the second flat surfaces 116 and 120 are all straight and flat. When the bolt is severely deformed, the first flat surface 112 and the second flat surfaces 116 and 120 cannot make complete contact with the sides of the bolt. Additionally, the inclined design of the grooves 114 and 118 results in the driving surface 106 easily slipping against the sides of the bolt when the socket is rotated. In other words, the first flat surface 112 and the second flat surfaces 116 and 120 disclosed in the driving surface 106 of the above-mentioned patent cannot achieve maximum clamping force to rotate severely deformed bolts effectively.

The present invention intends to provide a socket that is portable and removably attached to a tool such as a ratchet wrench.

The socket of the present invention includes first and second protrusions in specific shapes protruding from each face of the mounting hole of the socket so as to be securely engaged with a normal or rounded bolt head.

### SUMMARY OF THE INVENTION

The present invention relates to a socket and comprises a body which is a tubular and elongate body and includes a connection section and a driving section which is located co-axially to the connection section. A mounting hole is defined axially through the body. The mounting hole is a first hole in the connection section, and the mounting hole is a second hole in the driving section. The first hole is a rectangular hole, and the second hole is a polygonal hole. The connection section is removably attached to a tool.

The mounting hole includes multiple faces. Each face includes a first protrusion protruding from the central portion thereof. The first protrusion of each face includes a first flat distal surface which has a certain length. The first flat distal surface comprises two equally wide and intersecting first slope and second slope. A vertex is formed between the first slope and the second slope. Each first slope and each second slope has an inclined angle which is defined by the first slope, the second slope and a third imaginary plane. The third imaginary plane refers to a plane defined by a straight line passing through both the vertex and two points on the circumference of the socket, and the perpendicular bisector of the third imaginary plane passes through the center of the socket. A triangular notch is formed between any two adjacent first flat distal surfaces 30.

Multiple second protrusions protrude from each face of the mounting hole and are arranged into two groups. The first protrusion is located between the two groups of the second protrusions. Each second protrusion includes a second flat distal surface which has a certain length and is tilt relative to the first flat distal surface. The slope of each of the second flat distal surfaces of the second protrusions of each group is identical. The two respective slopes of the second flat distal surfaces of the two groups of the second protrusions are opposite to each other. A first imaginary plane is co-linear with the first flat distal surface. A second imaginary plane is co-linear with the second flat distal surfaces of each group of the second protrusions. An angle is defined between the first imaginary plane and each of the second imaginary planes.

Preferably, a groove is defined axially between adjacent faces of the mounting hole.

Preferably, a triangular notch is defined axially between adjacent second protrusions.

Preferably, the length of each second flat distal surface is longer than the length of each first flat distal surface.

Preferably, the length of each second flat distal surface is 0.56 mm, and the length of each first flat distal surface is 0.5 mm.

The primary object of the present invention is to provide a socket that is portable and removably attached to a tool. The socket is able to be securely mounted to a rounded or damaged nut or bolt head, and is able to loosen the rounded or damaged nut or bolt head.

The present invention will become more apparent from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is a top view of the present invention as shown in FIG. 1;

FIG. 3 is an exploded view of the present invention using a normal bolt;

FIG. 4 is a plane view of the present invention using a normal bolt;

FIG. 5 is an exploded view of the present invention using a worn bolt;

FIG. 6 is a plane view of the present invention using a worn bolt;

FIG. 7 is a plane view to show that the present invention rotates a worn bolt;

FIG. 8 is an enlarged view to show the present invention rotating a worn bolt;

FIG. 9 is a plane view to show the present invention rotating a worn bolt;

FIG. 10 is an enlarged plane view to show the present invention rotating a worn bolt, and

FIG. 11 is an enlarged view of the present invention showing the first flat distal surface and second flat distal surface.

### DETAILED DESCRIPTION OF THE PREFERRED EMBODIMENT

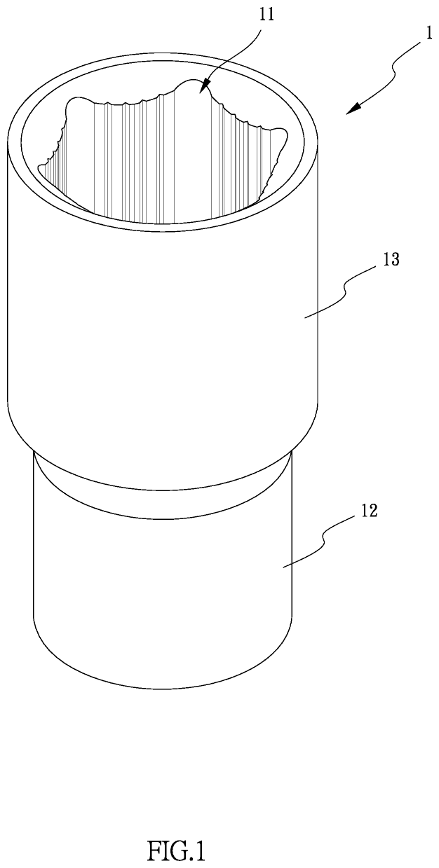

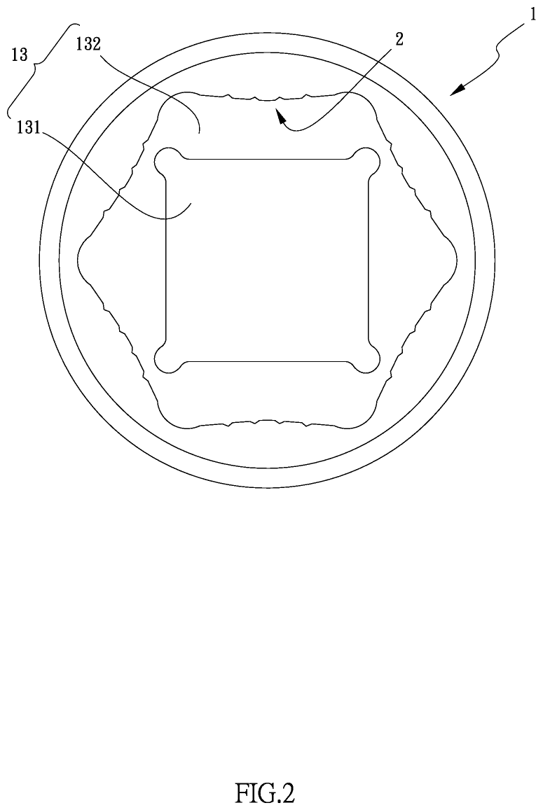

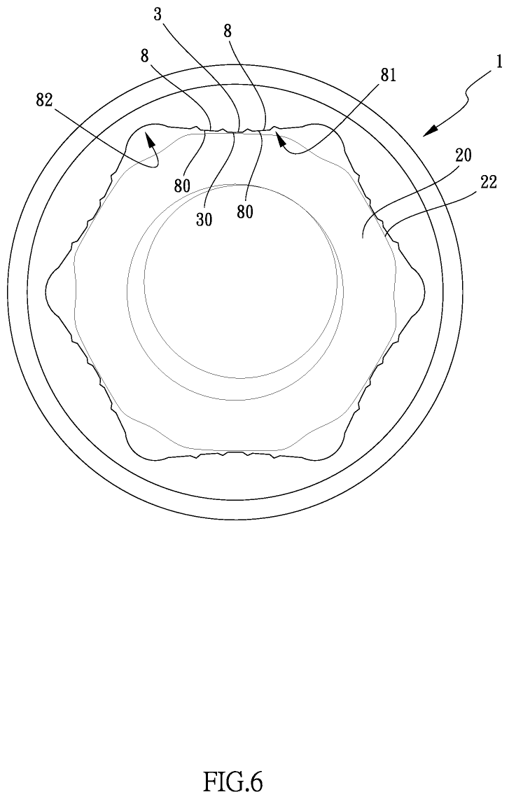

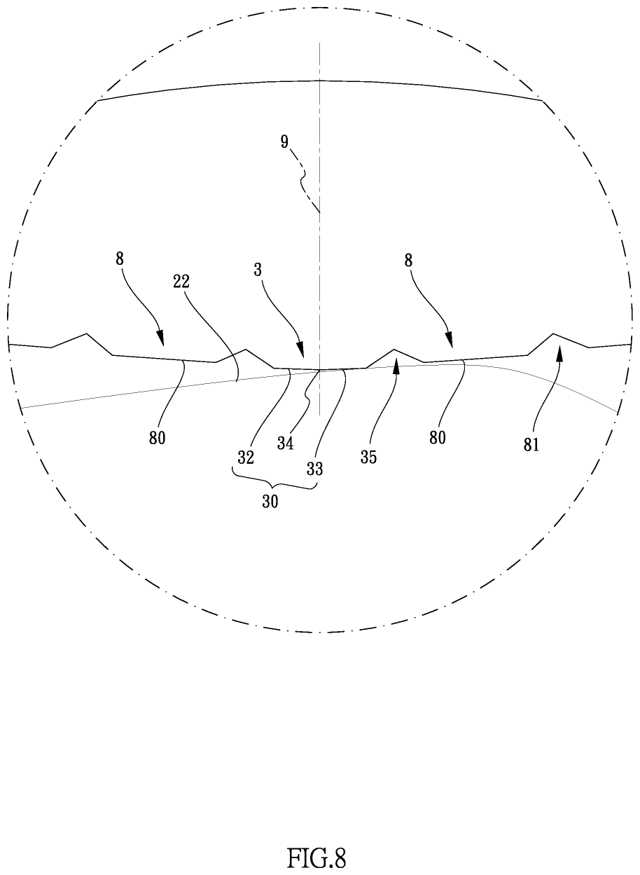

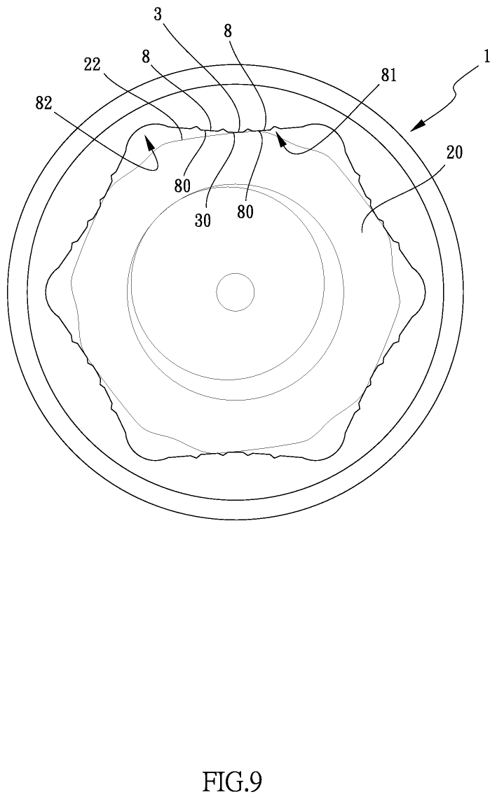

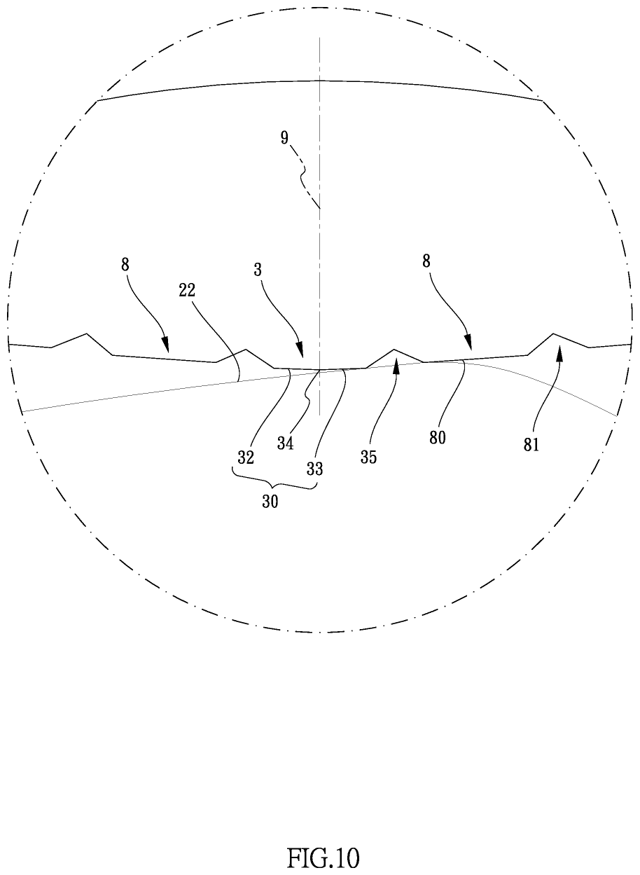

Referring to FIGS. 1 to 11, the socket 1 of the present invention is cooperated with a wrench 10 to loosen a bolt 20. The socket 1 comprises a body with a mounting hole 11 defined axially therethrough. The body is a tubular and elongate body. The body includes a connection section 12 and a driving section 13 which is located co-axially to the connection section 12. A mounting hole 11 is defined axially through the body. The mounting hole 11 is a first hole 131 in the connection section 12, and the mounting hole 11 is a second hole 132 in the driving section 13. The first hole is a rectangular hole, the second hole 132 is a polygonal hole. The connection section 12 is portable and removably attached to a tool such as a ratchet wrench. The driving section 13 is to be mounted to the bolt 20.

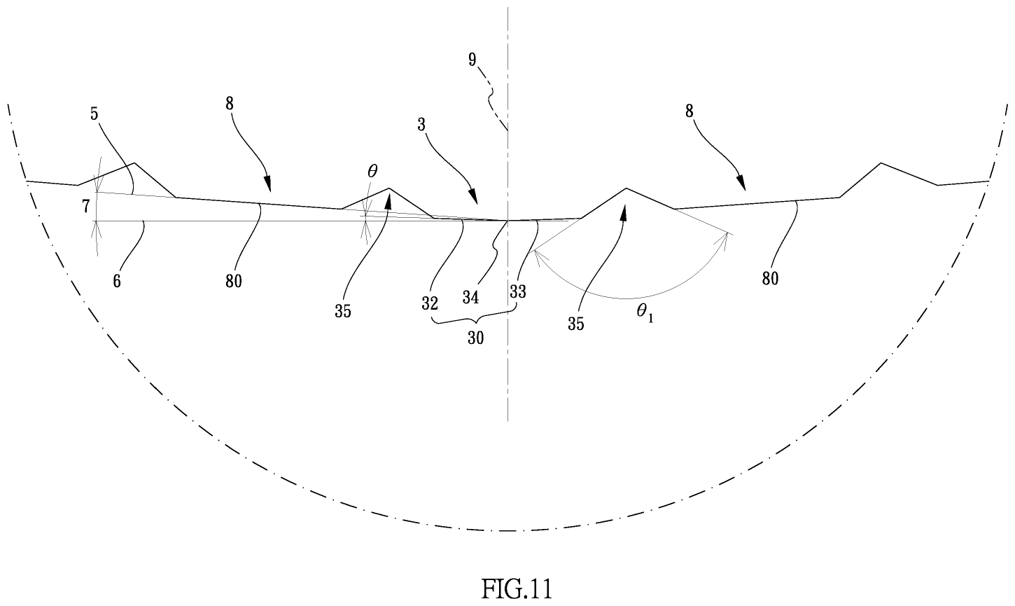

As shown in FIG. 11, the mounting hole 11 in the driving section 13 includes six faces 2, and each face 2 comprises a first protrusion 3 protruding from the central portion thereof. The first protrusion 3 of each face 2 includes a first flat distal surface 30. The first flat distal surface 30 comprises two equally wide and intersecting first slope 32 and second slope 33. A vertex 34 is formed between the first slope 32 and the second slope 33. Each first slope 32 and each second slope 33 has an inclined angle θ which is defined by the first slope 32 and the second slope 33 with a third imaginary plane 9. The third imaginary plane 9 refers to a plane defined by a straight line passing through both the vertex 34 and two points on the circumference of the socket 1. The perpendicular bisector of the third imaginary plane 9 passes through the center of the socket 1. A triangular notch 35 is formed between any two adjacent first flat distal surfaces 30. Each triangular notch 35 has a notch angle θ1 as shown in FIG. 11.

Multiple second protrusions 8 protrude from each face 2 of the mounting hole 11 and are arranged into two groups. The first protrusion 3 is located between the two groups of the second protrusions 8. In this embodiment, each group of the second protrusions 8 includes two second protrusions 8. Each second protrusion 8 includes a second flat distal surface 80 which has a certain length and is tilt relative to the first flat distal surface 30. Specifically, the slope of each of the two second flat distal surfaces 80 of the two second protrusions 8 of each group is identical. The two respective slopes of the second flat distal surface 80 of the two groups of the second protrusions 8 are opposite to each other.

A second imaginary plane 5 is co-linear with the two second flat distal surfaces 80 of each group of the second protrusions 8. An angle 7 is defined between the first imaginary plane 4 and each of the second imaginary planes 5. The angle 7 is larger than 0 degree, and the maximum value of the angle 7 is 5 degrees. Preferably, the angle 7 is 2 degrees.

A curved groove 82 is defined axially between any of the adjacent faces 2 of the mounting hole 11.

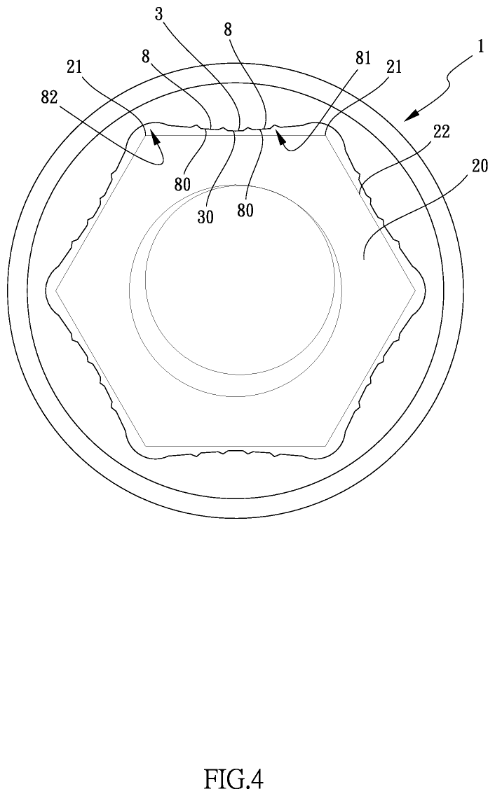

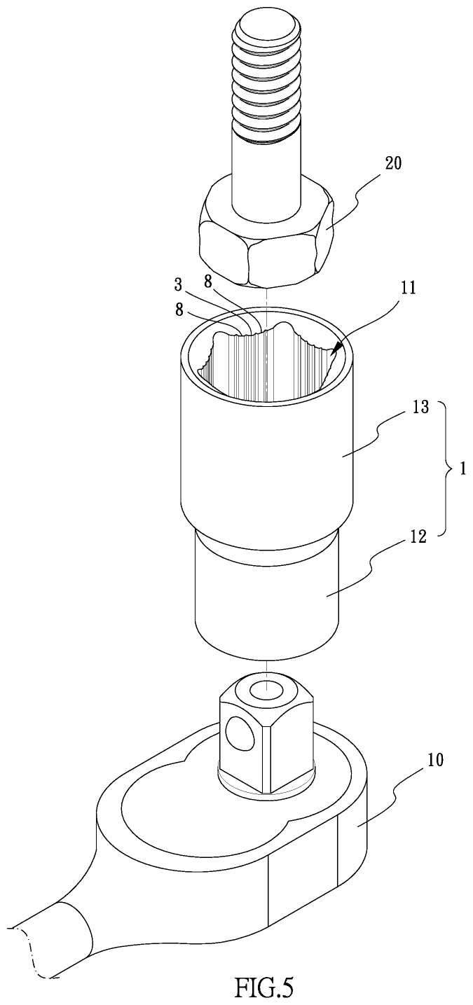

As shown in FIGS. 4 and 5, when loosening a normal bolt 20, the six sides of the head of the bolt 20 are in contact with the faces 2 of the mounting hole 11. When rotating the wrench 10, the socket 1 is rotated to rotate the bolt 20.

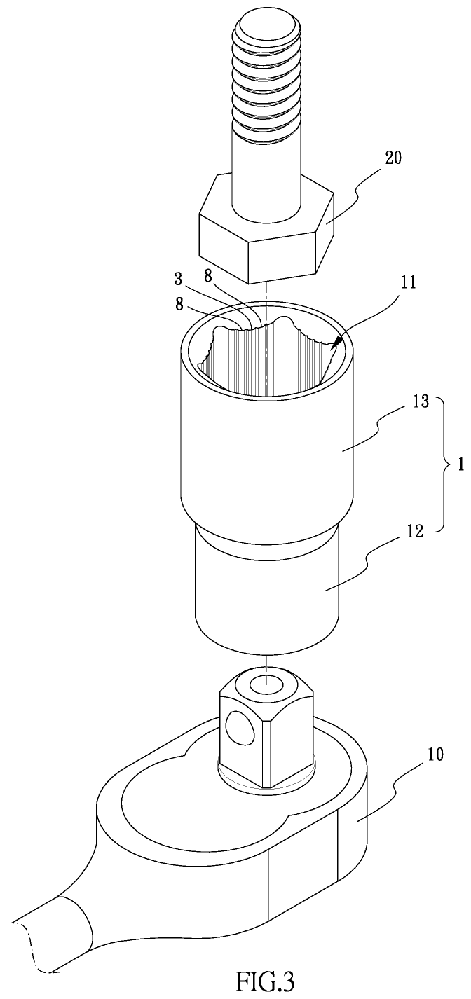

As shown in FIG. 3 and FIG. 4, when the mounting hole 11 of the socket 1 is mounted to a normal bolt 20, each corner 21 of the normal bolt 20 corresponds to the curved grooves 82 of the mounting hole 11, and the side 22 of the normal bolt 20 corresponds to the adjacent faces 2 of the mounting hole 11.

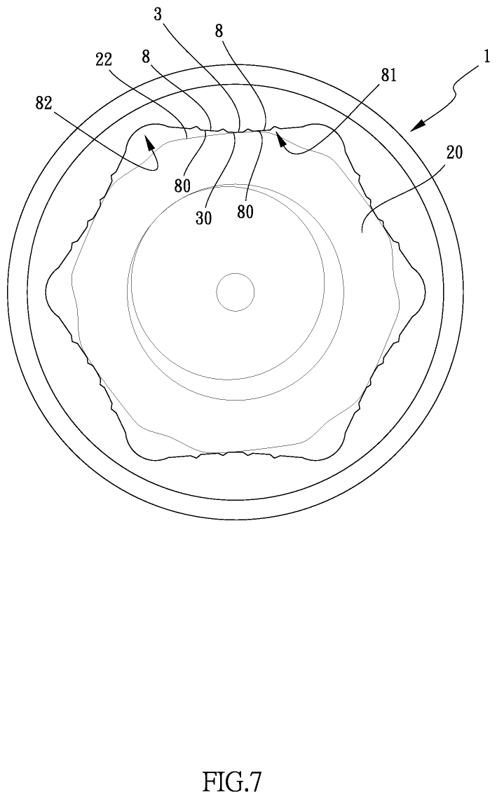

As shown in FIGS. 7-10, when the mounting hole 11 of socket 1 is mounted to a worn bolt 20, rotating socket 1 will initially make contact with the sides 21 of the worn bolt 20 simultaneously using the vertex 34 and the first slope 32 of the first flat distal surface 30. As socket 1 continues to rotate, contact with the sides 22 of the worn bolt 20 is maintained simultaneously using the second slope 33 and the second flat distal surfaces 80, forming a clamped state.

In other words, the first flat distal surface 30 and second flat distal surfaces 80 of socket 1 in this invention indeed have the ability to make face contact or linear contact with both normal and worn bolts 20, enabling socket 1 to rotate the bolt 20 effectively.

Based on this, this invention uses the inclined angles θ of the first slope 32 and the second slope 33 to create different contact situations between the first flat distal surface 30 and the bolt 20. In the illustration, for a worn bolt 20, when the inclined angle θ of the first slope 32 and the second slope 33 of the first flat distal surface 30 is 5°, the first flat distal surface 30 creates face contact with the bolt 20. When the inclined angle θ of the first slope 32 and the second slope 33 of the first flat distal surface 30 is 7°, the vertex 34 of the first flat distal surface 30 makes linear contact with the bolt 20. If it is necessary to rotate severely worn bolts 20, a mounting hole 11 with larger inclined angles θ for the first slope 32 and the second slope 33 of the first flat distal surface 30 should be selected. This will use the vertex 34 to clamp and embed into the side 22 of the bolt 20, creating a stronger contact and clamping force between the first flat distal surface 30 and second flat distal surfaces 80 and the severely worn bolt 20. This enables the socket 1 of the invention to be suitable for rotating normal, worn, and severely worn bolts 20.

The mounting hole 11 of this invention, with the inclined angles θ of the first slope 32 and the second slope 33 of the first flat distal surface 30, as well as the notch angle θ1 of the triangular notches 35, along with the design of the angle 7 on the two second flat distal surfaces 80 of the second flat distal surface as shown in FIG. 11, not only increases the strength of the mounting hole 11 itself, preventing damage or cracking of the mounting hole 11 during the rotation of the bolt 20 but also forms a tight engagement with the side 22 of the bolt 20.

One of the embodiments of the socket 1 is described hereinafter, wherein the length of each face 2 is 55 mm, and the width of each notch 81 is 0.38 mm and the depth of each notch 81 is 0.1 mm. The length of each second flat distal surface 80 is 0.56 mm, and the length of each first flat distal surface 30 is 0.5 mm. The socket 1 of the present invention can effectively rotate normal or rounded/damaged nut or bolt.

While we have shown and described the embodiment in accordance with the present invention, it should be clear to those skilled in the art that further embodiments may be made without departing from the scope of the present invention.

What is claimed is:

1. A socket (1) comprising:
a body being a tubular and elongate body, the body including a connection section (12) and a driving section (13) which is located co-axially to the connection section (12), a mounting hole (11) defined axially through the body, the mounting hole (11) being a first hole (131) in the connection section (12), the mounting hole (11) being a second hole (132) in the driving section (13), the first hole being a rectangular hole, the second hole (132) being a polygonal hole, the connection section (12) adapted to be removably attached to a tool, the mounting hole (11) in the driving section (13) including six faces (2), each face (2) comprising a first protrusion (3) protruding from a central portion thereof, the first protrusion (3) of each face (2) including a first flat distal surface (30) which has a certain length, multiple second protrusions (8) protruding from each face (2) of the mounting hole (11) and being arranged into two groups, the first protrusion (3) located between the two groups of the second protrusions (8), each second protrusion (8) including a second flat distal surface (80) which has a certain length and is tilt relative to the first flat distal surface (30), a slope of each of the second flat distal surfaces (80) of the second protrusions (8) of each group being identical, the two respective slopes of the second flat distal surfaces (80) of the two groups of the second protrusions (8) being opposite to each other;
a first imaginary plane (4) being co-linear with the first flat distal surface (30), a second imaginary plane (5) being co-linear with the second flat distal surfaces (80) of each group of the second protrusions (8), an angle (7) defined between the first imaginary plane (4) and each of the second imaginary planes (5), and
the first flat distal surface (30) comprising two equally wide and intersecting first slope (32) and second slope (33), a vertex (34) formed between the first slope (32) and the second slope (33), each first slope (32) and each second slope (33) having an inclined angle (θ) which is defined by the first slope (32) and the second slope (33) with a third imaginary plane (9), a triangular notch (35) formed between any two adjacent first flat distal surfaces (30), each triangular notch (35) having a notch angle (θ1).

2. The socket as claimed in claim 1, wherein when the inclined angle (θ) of each first slope (32) and each second slope (33) of the first flat distal surface (30) is 5°, the first flat distal surface (30) is adapted to contact one side (21) of a bolt (20).

3. The socket as claimed in claim 1, wherein when the inclined angle (θ) of each first slope (32) and each second slope (33) of the first flat distal surface (30) is 7°, the vertex (34) of the first flat distal surface (30) is adapted to contact the bolt (20), the first flat distal surface (30) is adapted to make a linear contact with a bolt (20).

4. The socket as claimed in claim 1, wherein when the mounting hole (11) of the socket (1) is adapted to be mounted to a worn bolt (20) and the socket is rotated, the vertex (34) and the first slope (32) of the first flat distal surface (30) is adapted to contact one side (21) of the worn bolt (20) simultaneously, as the socket (1) continues to rotate, the second slope (33) and the second flat distal surfaces (80) is adapted to contact with the side (22) of the worn bolt (20) simultaneously and forms a clamped state.

5. The socket as claimed in claim 1, wherein the angle (7) is larger than 0 degree, a maximum value of the angle (7) is 5 degrees.

6. The socket as claimed in claim 1, wherein the angle (7) is 2 degrees.

7. The socket as claimed in claim 1, wherein a groove (82) is defined axially between adjacent faces (2) of the mounting hole (11).

8. The socket as claimed in claim 1, wherein a triangular notch (81) is defined axially between the adjacent second protrusions (8) of each group of the second protrusions (8).

9. The socket as claimed in claim 1, wherein a length of each second flat distal surface (80) is longer than a length of each first flat distal surface (30).

10. The socket as claimed in claim 9, wherein the length of each second flat distal surface (80) is 0.56 mm, and the length of each first flat distal surface (30) is 0.5 mm.
